(19) United States
(12) Patent Application Publication
(10) Pub. No.: US 2015/0329753 A1
(43) Pub. Date: Nov. 19, 2015

(54) BIOBASED LIGNIN ADHESIVES FOR PLYWOOD APPLICATIONS AND MANUFACTURING OF IMPROVED WOOD-BASED PRODUCTS

(71) Applicant: Board of Trustees of the Leland Stanford Junior University, Palo Alto, CA (US)

(72) Inventors: Sarah L. Billington, Palo Alto, CA (US); Yi-Lin Chung, Palo Alto, CA (US); Jose A. Gutierrez, Palo Alto, CA (US); Russell Jingxian Li, Palo Alto, CA (US); Elizabeth Sattely, Palo Alto, CA (US)

(21) Appl. No.: 14/714,007

(22) Filed: May 15, 2015

Related U.S. Application Data
(60) Provisional application No. 61/994,681, filed on May 16, 2014.

(51) Int. Cl. C09J 197/00; D06M 15/55; C08L 97/02; C08H 7/00

(52) U.S. Cl. CPC C09J 197/005; C08H 6/00; D06M 15/55; C08L 97/02; D06M 2101/04

(57) ABSTRACT

Described herein is an adhesive formulation comprising lignin, a cross-linker, and optionally a dispersant, or obtained by mixing a composition comprising lignin, a cross-linker, and optionally a dispersant. Preferably in the adhesive formulation, at least about 50 wt. % of the composition is waste lignin, extracted lignin, or synthetic lignin; the lignin is not pre-activated, pre-fractionated, or pre-functionalized; the cross-linker is glycerol diglycidyl ether or poly(ethylene glycol)diglycidyl ether; and the dispersant is gamma-valerolactone, propylene carbonate, ethylene carbonate, or triacetin. Also described are methods for using the adhesive formulation for making plywood assemblies, lignin-fiber composites, and lignin-waste wood composites.

### CROSS-REFERENCE TO RELATED APPLICATIONS

This application claims the benefit of U.S. Provisional Patent Application No. 61/994,681 filed May 16, 2014, the content of which is incorporated herein by reference in its entirety.

### BACKGROUND

The industrial and commercial importance of wood products drives the design of eco-efficient wood adhesives to replace the range of widely used formaldehyde-containing adhesives.

Epoxides have been used as cross-linkers to produce lignin-epoxy adhesives. In such lignin-epoxy adhesives, lignin is usually pre-activated to increase its reactivity, or pre-fractionated to obtain soluble lignin fractions. The pre-activation often involves environmentally harsh processes (e.g. ozonolysis or use of sodium/potassium hydroxides). Whereas pre-fractionation of lignin often requires the use of large amount of solvent and heat to extract soluble portions of lignin. Activated or fractionated lignin is then reacted with epoxides to make lignin-epoxy resin. The use of unactivated native lignin involves reactive but harmful BPA-based epoxides. The resulting lignin-epoxy resin is then used as an adhesive. However, there has been no report of formaldehyde-free adhesives that employ the direct use of lignin, without the need for pre-activation.

### SUMMARY

Described herein are formaldehyde-free, bio-derived, lignin-based eco-efficient adhesives for plywood applications and furniture productions. For example, many embodiments relate to an adhesive formulation or composition comprising lignin, a cross-linker, and optionally a dispersant or diluent, or obtained by mixing a composition comprising lignin, a cross-linker, and optionally a dispersant or diluent.

In one embodiment, the lignin is waste lignin. In one embodiment, the lignin is extracted lignin. In one embodiment, the lignin is synthetic lignin. In one embodiment, the lignin is waste lignin such as biofuel-derived waste lignin. In one embodiment, the lignin is not pre-activated, pre-fractionated, or pre-functionalized, and is used as received. In one embodiment, at least or greater than about 50 wt. % of the formulation is lignin.

In one embodiment, the cross-linker is glycerol diglycidyl ether (GDE). In one embodiment, the cross-linker is poly(ethylene glycol)diglycidyl ether.

In one embodiment, the dispersant is gamma-valerolactone. In one embodiment, the dispersant is propylene carbonate. In one embodiment, the dispersant is ethylene carbonate. In one embodiment, the dispersant is triacetin.

In one embodiment, at least or greater than about 50 wt. % of the formulation is waste lignin, wherein the lignin is not pre-activated, pre-fractionated, or pre-functionalized, wherein the cross-linker is glycerol diglycidyl ether, and wherein the dispersant is gamma-valerolactone.

In one embodiment, the lignin is processed by a homogenization process such as ball mill homogenization. In one embodiment, the lignin is processed by rapid (e.g., 5 minutes or less) ball mill homogenization. In one embodiment, the lignin has an average particle size of 100 μm or less, or 50 μm or less, or 40 μm or less, or 30 μm or less.

In one embodiment, the formulation comprises an amount of the cross-linker effective for transitioning the formulation into a liquid state such as at room temperature or about 25° C. In one embodiment, the formulation comprises about 35 wt. % or more of the cross-linker such as GDE. In one embodiment, the formulation comprises about 40 wt. % or more of the cross-linker such as GDE. In one embodiment, the formulation comprises about 45 wt. % or more of the cross-linker such as GDE. In one embodiment, the formulation comprises about 50 wt. % or more of the cross-linker such as GDE. In one embodiment, the formulation comprises about 55 wt. % or more of the cross-linker such as GDE. In one embodiment, the formulation comprises about 60 wt. % or more of the cross-linker such as GDE.

In one embodiment, the formulation comprises about 30 wt. % or less of the dispersant. In one embodiment, the formulation comprises about 25 wt. % or less of the dispersant. In one embodiment, the formulation comprises about 20 wt. % or less of the dispersant. In one embodiment, the formulation comprises about 15 wt. % or less of the dispersant. In one embodiment, the formulation comprises about 10 wt. % or less of the dispersant.

In one embodiment, the formulation has a viscosity of 10 Pa·s or less. In one embodiment, the formulation has an adhesion strength of 1-5 MPa, or 1-4 MPa, or 2-3 MPa, or about 2.2 MPa (T, ultimate shear stress).

In one embodiment, the formulation consists essentially of the lignin and the cross-linker, and wherein the formulation is in a liquid state such as at room temperature or about 25° C. In one embodiment, the formulation consists essentially of the lignin and GDE, and wherein the formulation is in a liquid state such as at room temperature or about 25° C.

In one embodiment, the formulation consists essentially of the lignin, the cross-linker and the dispersant, and wherein the formulation is in a liquid state. In one embodiment, the formulation consists essentially of the lignin, GDE and the dispersant, and wherein the formulation is in a liquid state.

Other embodiments relate to a method for making a lignin-epoxy resin, comprising curing the adhesive formulation described herein, as well as a lignin-epoxy resin made thereby.

Further embodiments relate to a method for making a plywood assembly, comprising applying the adhesive formulation described herein onto plywood and curing the adhesive formulation, as well as a plywood assembly made thereby.

Yet other embodiments relate to a method for making a lignin-fiber composite, comprising applying the adhesive formulation described herein onto burlap fiber and curing the adhesive formulation, as well as a lignin-fiber composite made thereby.

Yet further embodiments relate to a method for making a lignin-waste wood composite, comprising mixing the adhesive formulation described herein with waste wood or waste lignocellulose and curing the resulting mixture, as well as a lignin waste wood composite made thereby.

These and other features, together with the organization and manner of operation thereof, will become apparent from the following detailed description when taken in conjunction with the accompanying drawings.

### BRIEF SUMMARY OF THE FIGURES

FIG. 1. Ultimate shear strength of three-ply plywood. Com 1 and Com 2 are two different commercial three-ply plywood. HS and FS are three-ply plywood samples assembled using various formulations of lignin, cross-linker, and dispersant. Dry refers to results from test in accordance to ASTM D906; wet refers to results from tests where samples were soaked in deionized water for 48 h prior to testing, in accordance to ASTM D4690. A value of 1.93 MPa for ultimate sheer stress is the minimum requirement for substitutes for formaldehyde-based adhesives prescribed in ASTM D4690, section 11.2.3.2.

FIG. 2. Ultimate tensile strength of Lignin-Jute composite in comparison with other composite materials.

FIG. 3. Tensile modulus of Lignin-Jute composite in comparison with other composite materials.

FIG. 4. Bending stress of Lignin-Jute composite in comparison with other composite materials. LJ_{—}6P_FS_{—}01, LJ_{—}6P_FS_{—}02, and LJ_{—}6P_FS refer to lignin-jute composite fabricated with various resin formulations. PP denotes polypropylene.

FIG. 5. Bending modulus of Lignin-Jute composite in comparison with other composite materials. LJ_{—}6P_FS_{—}01, LJ_{—}6P_FS_{—}02, and LJ_{—}6P_FS refer to lignin jute composite fabricated with various resin formulations. PP denotes polypropylene.

FIG. 6 shows a lignin-fiber composite described herein.

FIG. 7 shows a lignin-waste wood composite described herein.

FIG. 8 shows adhesive strength of lignin based epoxy made using indulin AT lignin as received and GDE (as labeled) and PEGDE (as labeled) in about 1:1 molar ratio of OH groups on lignin to epoxy groups. Comm 1 and Comm 2 are results from two different commercial plywood samples, and Elmer and Titebond II are adhesive strengths of commercial wood glues.

FIG. 9 shows images of a resin, which can be crumbly and hard to disperse evenly on a surface. In order for the resin to be more commercially viable at the industrial scale, it is desirable for it to be a direct drop-in replacement for formaldehyde-based adhesives. One of the criteria for resin to be a drop-in replacement is for its physical state to be liquid, and meets viscosity of ˜2 Pa·s.

FIG. 10 shows an amount GDE for a resin to transition to liquid state. REG=lignin used as received; COA=lignin with particle size from 250-500 μm; FINE=lignin with particle size from <38 μm; GRD=REG that is subjected to rapid ball mill homogenization (30 Hz, 5 min); COA-G=COA that is subjected to rapid ball mill homogenization (30 Hz, 5 min). Use of ball mill homogenized lignin (GRD) allows less GDE for formulation to transition to liquid state.

FIG. 11 shows effects of size of lignin on adhesion strength. REG=lignin used as received; COA=lignin with particle size from 250-500 μm; FINE=lignin with particle size from <38 μm; GRD=REG that is subjected to rapid ball mill homogenization (30 Hz, 5 min); COA-G=COA that is subjected to rapid ball mill homogenization (30 Hz, 5 min). Use of ball mill homogenized lignin (GRD) also results in greater adhesion strength.

FIG. 12 shows effects of increased GDE loading on viscosity and adhesion strength. Use of additional GDE to transform resin to liquid state does not decrease resulting adhesion strength.

FIG. 13 shows images of resins with increasing GDE loading.

FIG. 14 shows effects of replacing GDE with diluents. GRD=lignin subjected to rapid ball mill homogenization (30 Hz, 5 min); DIL=Diluent; GVL=gamma-valerolactone; PC=propylene carbonate; TA=Triacetin. Use of diluent results in lower cost of resin, retains liquid state of resin, as well as retains its adhesion strength.

FIG. 15 shows a weathering test of samples soaked in water to test tolerance to wet conditions.

FIG. 16 shows adhesion strength of Lignin-Based Epoxy (LBE) with 50 wt % total lignin content and 50 wt. % of GDE. Alkaline (TCI)=alkaline lignin from TCI; Dealkaline (TCI)=dealkaline lignin from TCI; Kraft=kraft lignin from Sigma; Kraft, low=low-sulfonate kraft lignin from Sigma; WS=walnut shells; WS-enzymatic=enzymatically digested WS; WS-sulfuric acid=sulfuric acid digested WS; GRD=ball mill homogenized indulin AT lignin. The process is general and can be applied to waste lignin from various industrial streams.

### DETAILED DESCRIPTION

Embodiments of the invention herein described are directed to a lignin-based epoxy resin that can be used in plywood manufacturing, as well as in the fabrication of improved wood products with waste-wood. The procedure for use is streamlined and environmentally benign. Adhesion can be achieved via direct cross-linking with bio-derived cross-linkers without the need for pre-activation, pre-fractionation, or pre-functionalization of lignin. Adhesion can also be achieved via catalytic repolymerization of lignin under aerobic conditions. The resulting formulation can have high lignin content (e.g., up to about 60 wt. % or more) with overall total bio-derived feedstock content of up to about 100 wt. %. The resulting bio-based adhesive formulation can have high lignin content and can consist of (or consisting essentially of) environmentally friendly and non-toxic components. Together with its ease of use in plywood assembly this formulation is suitable for large-scale industrial applications.

Lignin generated as waste product from the pulp and paper industry can be directly utilized in high proportions with bio-derived chemical reagents for the synthesis of epoxy resin as adhesives in the manufacturing of plywood. Embodiments of the invention can be used as a wood adhesive. In particular, the adhesive can be used to fabricate 3-ply plywood, and has been shown to outperform commercially used glue.

The adhesive formulation described herein has many unique properties. First, the adhesive formulation affords adhesion without the use of formaldehyde. Formaldehyde is a key component in many widely used wood products. The emission of formaldehyde post-manufacturing, however, has health risks. The formulation can be, for example, substantially free of formaldehyde, such as less than about 5 wt. %, less than about 2 wt. %, or less than about 1 wt. %.

Second, the adhesive formulation utilized waste lignin directly, avoiding the need for pre-functionalization, pre-fractionation, or other pre-treatment processes that often involve environmentally harsh conditions. The synthetic method is green and does not involve the use of strong base (e.g., sodium hydroxide).

Third, the adhesive formulation comprises a high proportion of lignin, with lignin up to about 60 wt. % or more. Fourth, the components of the adhesive formulation can be completely or primarily bio-derived, with bulk content (e.g., up to 90 wt. % or more) being by-product of industrial processes.

Further, the adhesive formulation can include higher lignin content and/or additional additives to improve its adhesion strength. In addition, the formulation can be used together with waste-wood (e.g., sawdust) in the fabrication of improved materials. The formulation has various advantages including low cost, ease of use, streamlined procedure; direct use of waste lignin, no need for pre-treatment, pre-functionalization, pre-fractionation, or pre-activation of lignin; high lignin content; and the use of bio-derived reagents that are environmentally green and health-friendly.

The adhesive formulation can comprise, for example, lignin, a cross-linker, and a dispersant. The formulation can comprise, for example, at least about 30 wt. %, or at least about 40 wt. %, or at least about 50 wt. %, or at least about 55 wt. % of lignin. The formulation can comprise, for example, about 10 wt. % to about 40 wt. %, about 20 wt. % to about 40 wt %, or about 30 wt. % of the cross-linker, and can comprise, for example, about 5 wt. % to about 20 wt. %, about 10 wt. % to about 15 wt. %, or about 12 wt. % of the dispersant.

The lignin can comprise, for example, waste lignin, extracted lignin, or synthetic lignin. The lignin can comprise, for example, at least about 30 wt. %, or at least about 50 wt. %, or at least about 80 wt. % of waste lignin. The lignin can be, for example, substantially free of pre-activated, pre-fractionated, or pre-functionalized lignin, such as less than about 5 wt. %, less than about 2 wt. %, or less than about 1 wt. %. The lignin can comprise, for example, lignin-derived bio-composites such as PLA-lignin.

The cross-linker can comprise, for example, glycerol diglycidyl ether. The cross-linker can comprise, for example, poly(ethylene glycol)diglycidyl ether. Other cross-linkers including two or more glycidyl ether groups are contemplated, such as ethylene glycol diglycidyl ether, diethylene glycol diglycidyl ether, poly(ethylene glycol)diglycidyl ether or other poly(alkylene glycol)diglycidyl ether, polyglycerol polyglycidyl ether, propylene glycol diglycidyl ether, glycerol triglycidyl ether, and so forth. The cross-linker can comprise, for example, other bio-derived reagents such as lactide. In lieu of a cross-linker, the formulation can also comprise a catalyst to catalyze the self-polymerization of lignin.

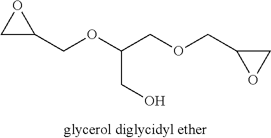 [SMILES: OCC(COCC1CO1)OCC1CO1]

The dispersant can comprise, for example, gamma-valerolactone. The dispersant can comprise, for example, propylene carbonate. The dispersant can comprise, for example, ethylene carbonate. The dispersant can comprise, for example, triacetin. In a particular embodiment, the dispersant is gamma-valerolactone. Other cyclic esters are contemplated, such as with a three-membered ring, a four-membered ring, a five-membered, a six-membered ring, or a higher-membered ring, optionally substituted at one or more carbon atoms with C1-C10, C1-C5, or C1-C3 alkyl groups, hydroxyl groups, or other substituent groups. Also, other cyclic and non-cyclic carbonate esters are contemplated, such as other cyclic carbonate esters in which a carbonate ester group is bridged by two, three, four, or more carbon atoms, optionally substituted at one or more carbon atoms with C1-C10, C1-C5, or C1-C3 alkyl groups, hydroxyl groups, or other substituent groups. Also, other mono-, di-, and triglycerides are contemplated. The formulation can also comprise other solvent to form a liquid formulation.

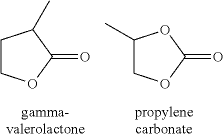

The adhesive formulation can be cured to make a lignin-epoxy resin by applying, for example, heat or pressure.

The adhesive formulation can be used to make a plywood assembly, comprising applying the adhesive formulation described herein onto plywood and curing the adhesive formulation.

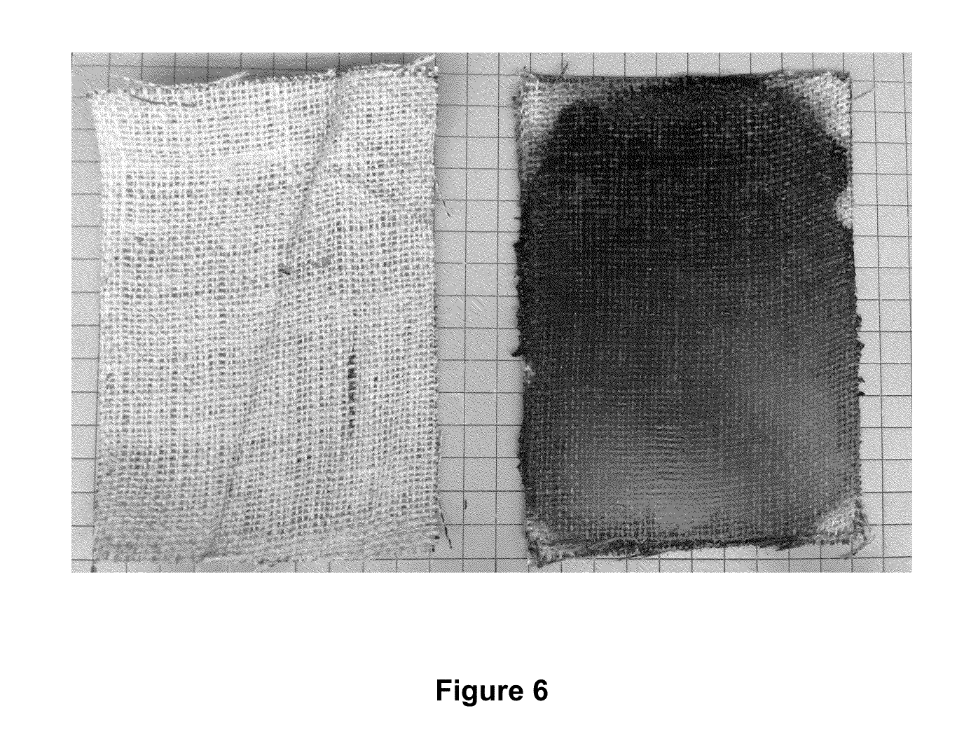

The adhesive formulation can be used to make a lignin-fiber composite, comprising applying the adhesive formulation described herein onto a fiber material and curing the adhesive formulation. The fiber material can be, for example, jute burlap fiber (See FIG. 6).

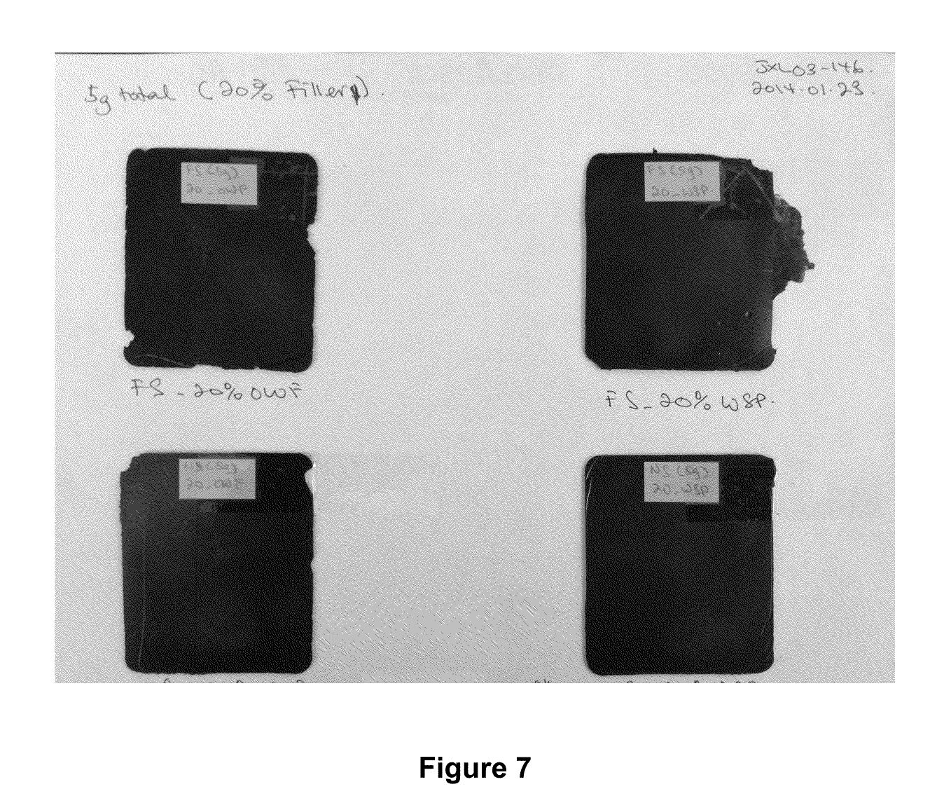

The adhesive formulation can be used to make a lignin-waste wood composite, comprising mixing the adhesive formulation described herein with waste wood or waste lignocellulose and curing the resulting mixture. The waste wood or waste lignocellulose can be, for example, sawdust, oakwood flour, or walnut shell powder. Lignin-epoxy resin can be used as a matrix to upcycle such industrial and agricultural byproducts into higher utility materials. In one embodiment, ground up wood flour (or walnut shell powder) is blended with the adhesive formulation described herein, with the resulting mixture heated (e.g., about 150° C.) in a mold to produce plastic-like panels (See FIG. 7).

These and other features, together with the organization and manner of operation thereof, will become apparent from the following detailed description when taken in conjunction with the accompanying drawings.

### WORKING EXAMPLES

### 1. Experimental Section

1.1 Materials and Methods

Lignin (Indulin AT) was purchased from Westvaco, Charleston, S.C., and kept dry at 95° C. for at least 1 day prior to use. Glycerol diglycidyl ether (GDE), poly(ethylene glycol)diglycidyl ether (PEGE) gamma-valerolactone (GVL), ethylene carbonate (EC), propylene carbonate (PC), and triacetin (TA) were purchased from Sigma-Aldrich and used as received without further purification or fractionation. Birch veneer (thickness=1.59 mm) was purchased from Roarockit Skateboard Company. Undied, virgin jute burlap with standard processing conditions was acquired from onlinefabricstore.com under the trade names BUR60 60 Inch Natural Burlap. Commercial wood adhesives Super Sap®100/1000 (Entropy Resin), Liquid Nail LN-740 (Multi-purpose wood Products™ construction adhesive)(Liquid Nails® Adhesive), and Loctite® epoxy (Instant Mix™ 5 Minute)(Henkel Corp.) were also used for plywood assembly for comparison of adhesive strength.

1.2 Preparation of Biobased Lignin Resin

Biobased resin was prepared by mixing lignin (cooled to room temperature), cross-linker (GDE and/or PEGE), and dispersant (GVL, EC, PC, and/or TA) at room temperature right before use.

1.3 Sample Procedure for Assembling of Three-Ply Plywood

Resin was prepared by mixing lignin, cross-linker, and dispersant at room temperature right before application to veneer sheets. In this example, the components are lignin (58 wt %), cross-linker (GDE, 32 wt %) and dispersant (GVL, 12 wt %). The resulting mixture was spread evenly on each side of the birch veneers (250×250×1.59 mm) in contact with another piece of veneer. The three-ply specimens were reassembled with the fiber direction of the center veneer perpendicular to the two face veneers. The specimen was kept on the hot-presser (PHI-Tulip Model 225H-X6-13, USA) at 150° C. for 10 min, followed by hot-pressed at 150° C. for 5 min under a pressure of 1.0 MPa. Then the plywood was pressed under a constant weight of 100 kg at room temperature for at least 12 h. The application of commercial adhesives to plywood assembly was in accordance with the adhesive manufacturer's instructions. After processing, the resulting assembly shall remain in an iso-thermal, constant relative humidity environment of RH=20% for at least 12 h prior to mechanical testing.

1.4 Sample Procedure for Fabricating Jute-Lignin Composite

Resin was prepared by mixing lignin, cross-linker, and dispersant at room temperature right before fabricating composite. Resin was spread between six layers of jute burlap, each measuring 178×229 mm, at a resin loading of 50 mg/cm² between each interface. The samples were then pressed in a hot press (PHI-Tulip Model 225H-X6-13, USA), at 150° C. for 1 minute at 0.2 MPa, and a further 9 minutes at 1 MPa. After removal from the hotpress, the specimens were left to cool for over 24 hours under constant weight of 100 kg.

1.5 Preparation of Samples for Mechanical Tests

The specimens were then cut into specific dimensions using LaserCAMM laser cutter. Composite for tensile tests were cut to meet the dimension specifications of ASTM D638 for type 1 specimens. Flexural specimens were cut to meet dimension specifications of ASTM D790. The dimensions of the flexural composites for this analysis were approximately 3 mm thick, 12.7 mm wide, and 82.5 mm long with a span length of 56 mm. The shear strength of 3-ply plywood veneers was tested according to ASTM D906.

### 2. Mechanical Testing

2.1 Adhesion Strength of Resin in Three-Ply Plywood

The adhesion strength of resin was determined by measuring the interfacial shear strength in accordance to ASTM D906. Adhesive shear strength was tested under wet conditions according to ASTM D4690

2.2 Tensile Tests

Tensile specimens were tested in tension according to ASTM Standard D638, using a MTS model 858 Table Top System. Gage strain was measured with MTS 50 mm extensometer. The crosshead speed was set to a rate of 5 mm per minute.

2.3 Flexural Tests

Flexural tests were using a three point bending setup according to ASTM Standard D790, using a MTS model 858 Table Top System. The displacement of the crosshead was taken to be the displacement of the flexural specimen. The crosshead speed was calculated for each specimen as specified in ASTM D790.

2.4 Determination of Tensile and Flexural Modulus of Specimen

Tensile and flexural modulus were determined from the stress vs. engineering stain curve for the composite between 5% and 40% of the ultimate strength, which was determined to be below the yield point.

### 3. Results

3.1 Interfacial Shear Strength of Three-Ply Plywood

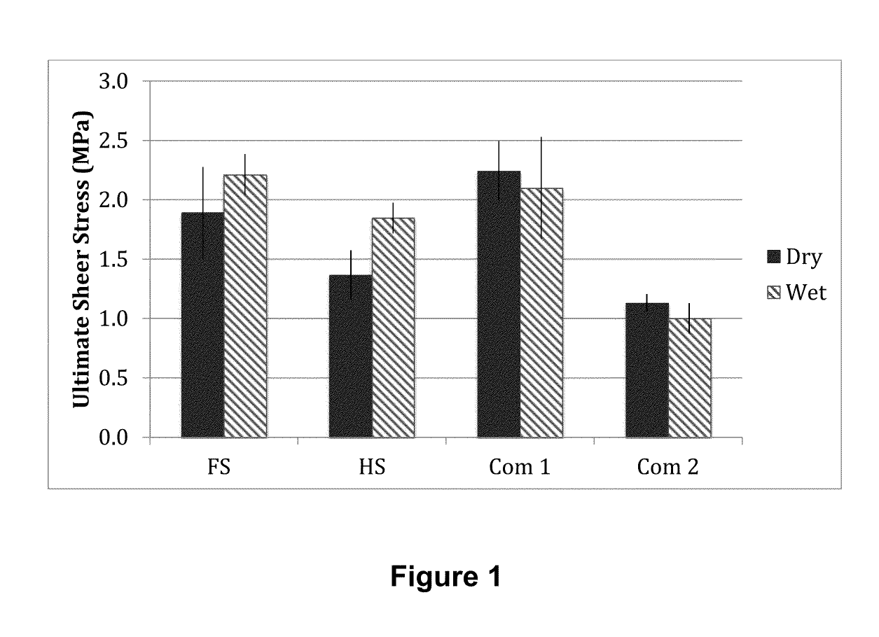

Interfacial shear strength of three-ply plywood is a direct measurement of the adhesion strength of the resin, and is determined in accordance to ASTM D906. The ultimate adhesive shear strength of the samples prepared with various resin formulation (denoted by HS, FS) were found to be comparable to adhesive shear strengths from commercial plywood sample tested (denoted by Com 1, and Com 2). In order to effectively replace formaldehyde resins used in plywood manufacturing, the lignin-based resins must not be susceptible to water-initiated hydrolysis. As such, we further compared the adhesion strength of the samples after the samples were soaked in deionized water for 48 h, in accordance to ASTM 4690. The lignin resin sheer strength was found to be uncompromised in the soaked samples (denoted by wet test). It is also worth noting that soaking the samples lead to higher shear strengths, and a smaller sample standard deviation. The results are summarized in FIG. 1.

3.2 Ultimate Tensile Strength and Tensile (Young's) Modulus of Jute Fiber Reinforced Composite

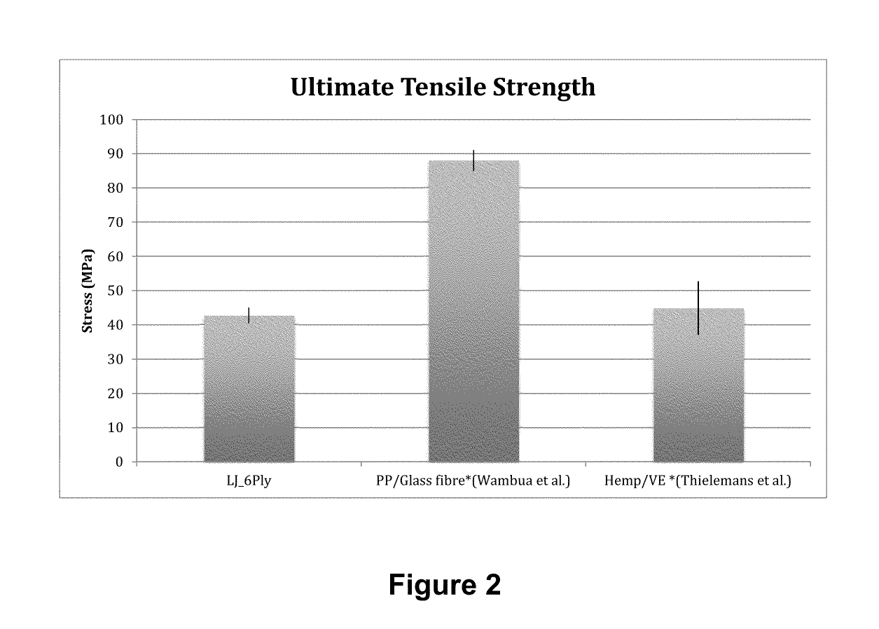

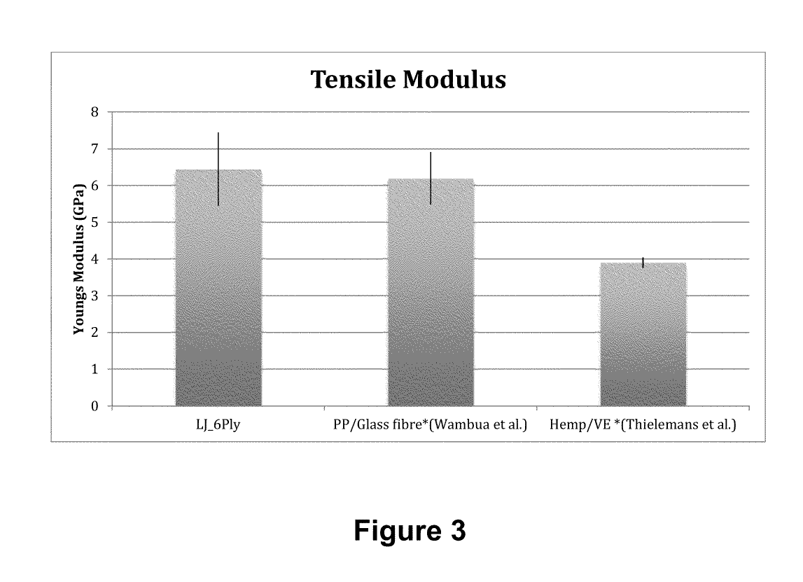

The tensile properties and bending of the on axis Jute fiber reinforced composites were characterized according to ATSM standards. The ultimate tensile strength was found to be 42.7 MPa, in the same order of magnitude with some other composite materials. (FIG. 2) Lignin jute composite displays a Young's Modulus of 6.44 GPa, surpassing the same composite materials aforementioned. (FIG. 3) Hemp/VE denotes a composite made with hemp natural fiber and a vinyl ester, a fossil fuel-derived matrix polymer; whereas PP/Glass fiber denotes a composite made from synthetic glass fiber and polypropylene, also a fossil fuel-derived polymer. We hence show here that the bio-derived Jute-lignin composites have similar ultimate strengths and stiffness to other synthetic and natural composites.

3.3 Ultimate Bending Strength and Bending Modulus of Jute Fiber Reinforced Composite

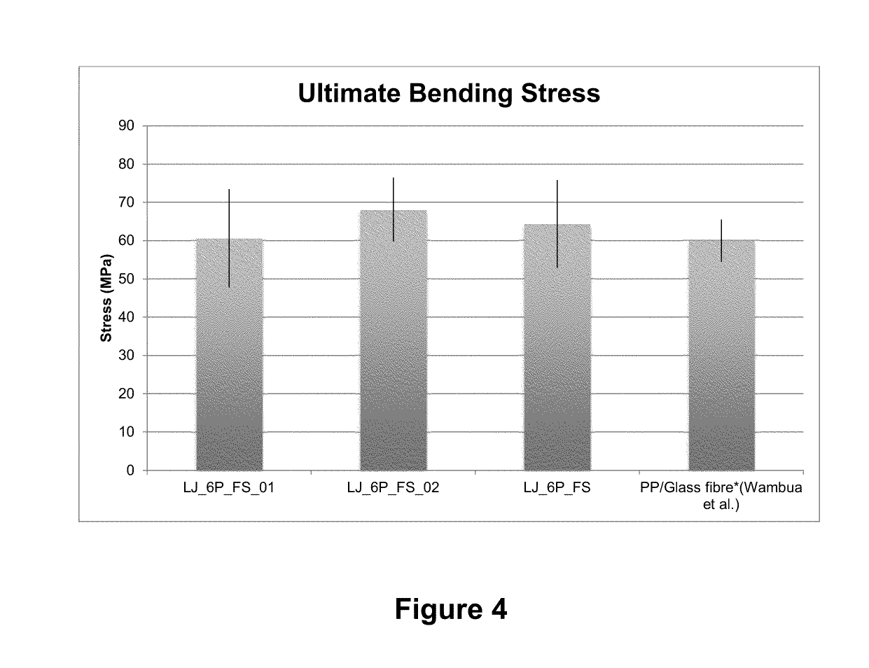

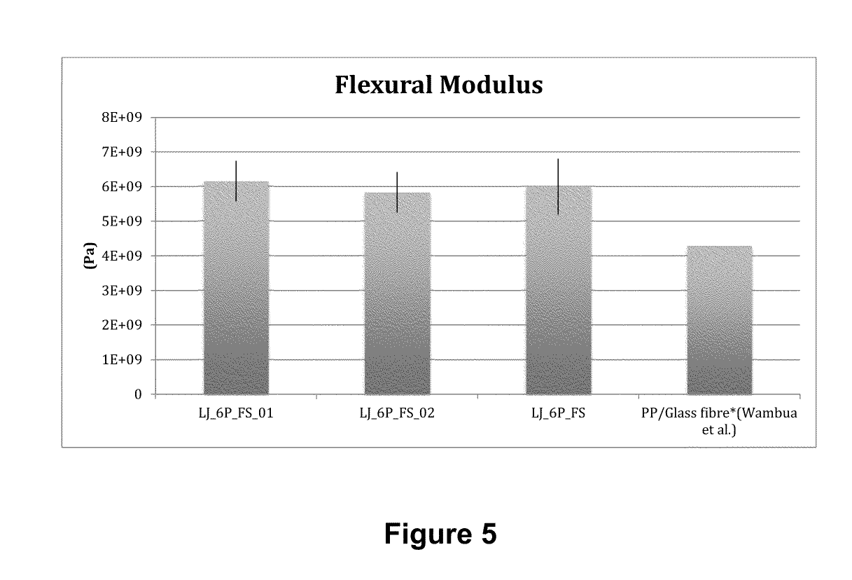

The bending properties were determined as per described in section 2.4. As shown in FIGS. 4 and 5, the lignin jute composite prepared with various resin formulations display comparable mechanical property with a polypropylene-glass fiber composite, denoted by PP/Glass fiber.

### 4. Additional Experimental Results

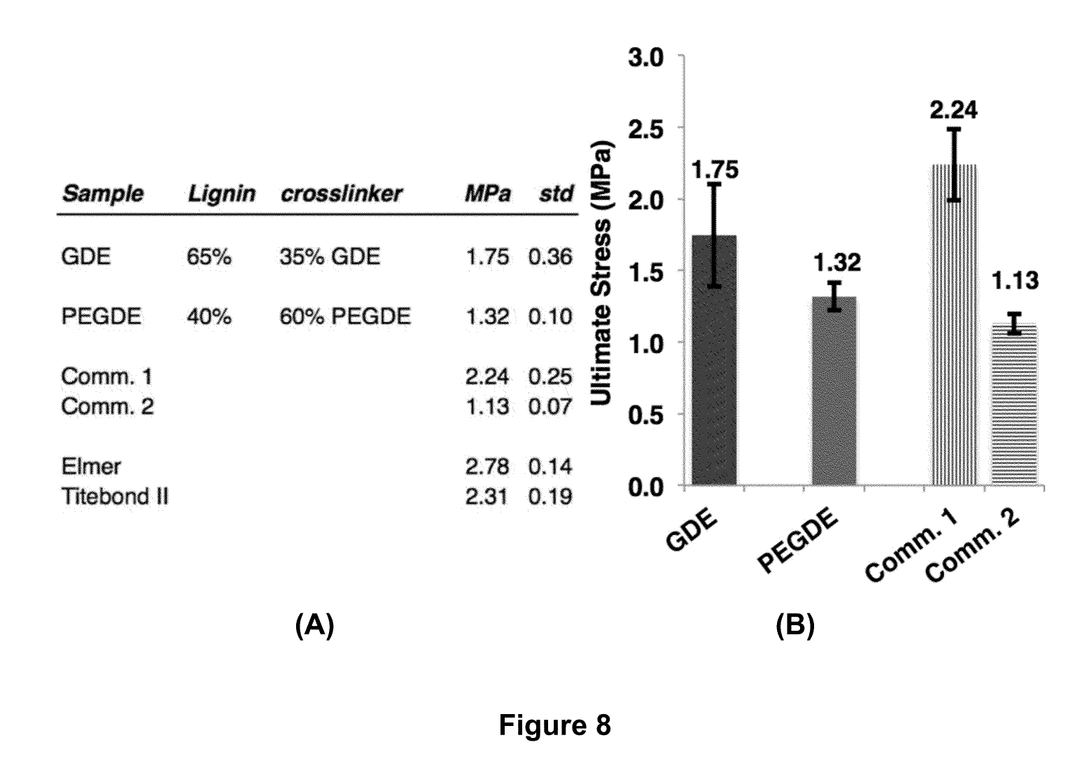

As shown in FIG. 8, adhesive strength of lignin based epoxy made using indulin AT lignin as received and GDE (as labeled) and PEGDE (as labeled) were tested, wherein the molar ratio of lignin-OH groups to epoxy groups is about 1:1. Comm 1 and Comm 2 are results from two different commercial plywood samples, while Elmer and Titebond II are adhesive strengths of commercial wood glues.

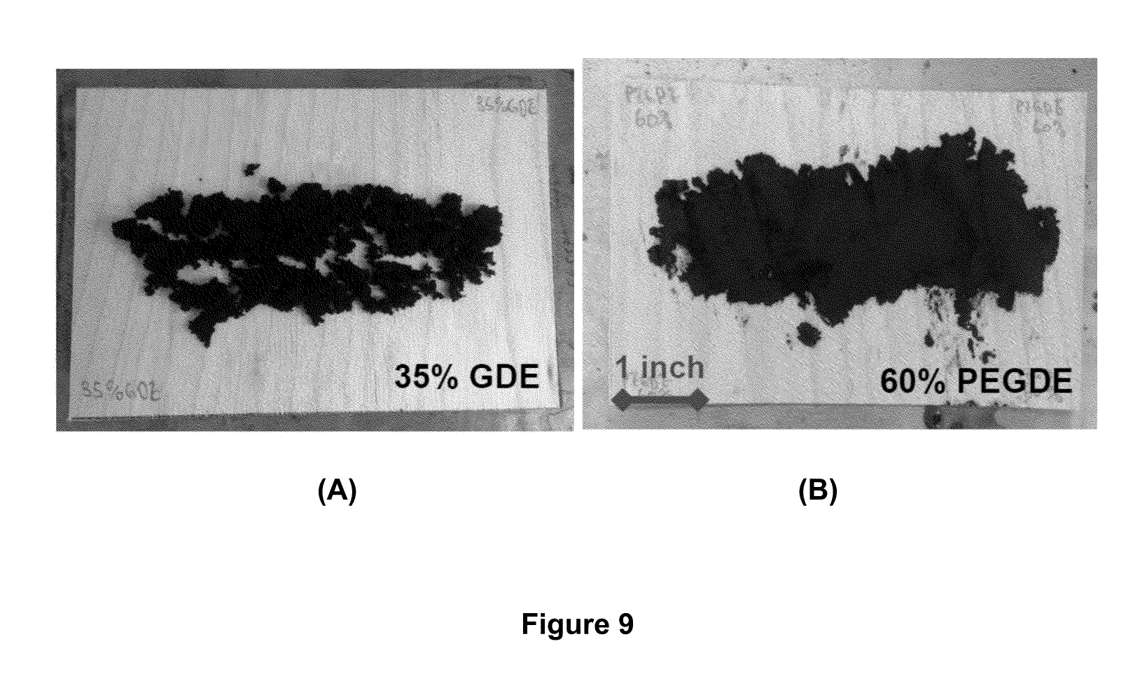

As shown in FIG. 9, the lignin-based resin without a sufficient amount of cross-linker or dispersant/diluent can be crumbly and hard to disperse evenly on a surface. In order for the lignin-based resin to be more commercially viable at industrial scale, it is desirable for it to be a direct drop-in replacement for formaldehyde-based adhesives. One of the criteria for the lignin-based resin to be a drop-in replacement is for its physical state to be liquid, and meets viscosity of ˜2 Pa·s.

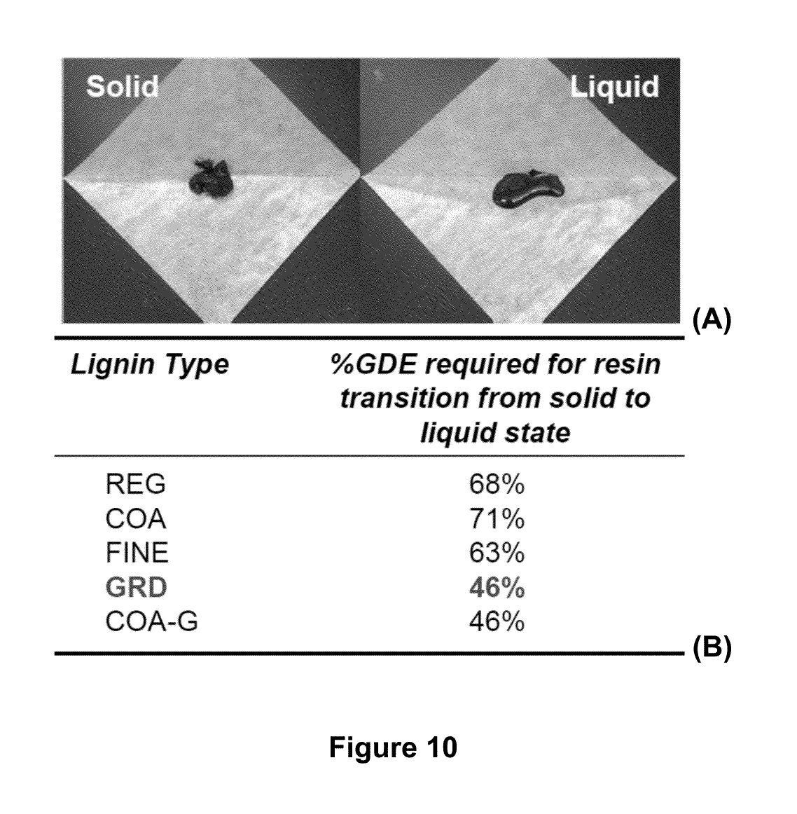

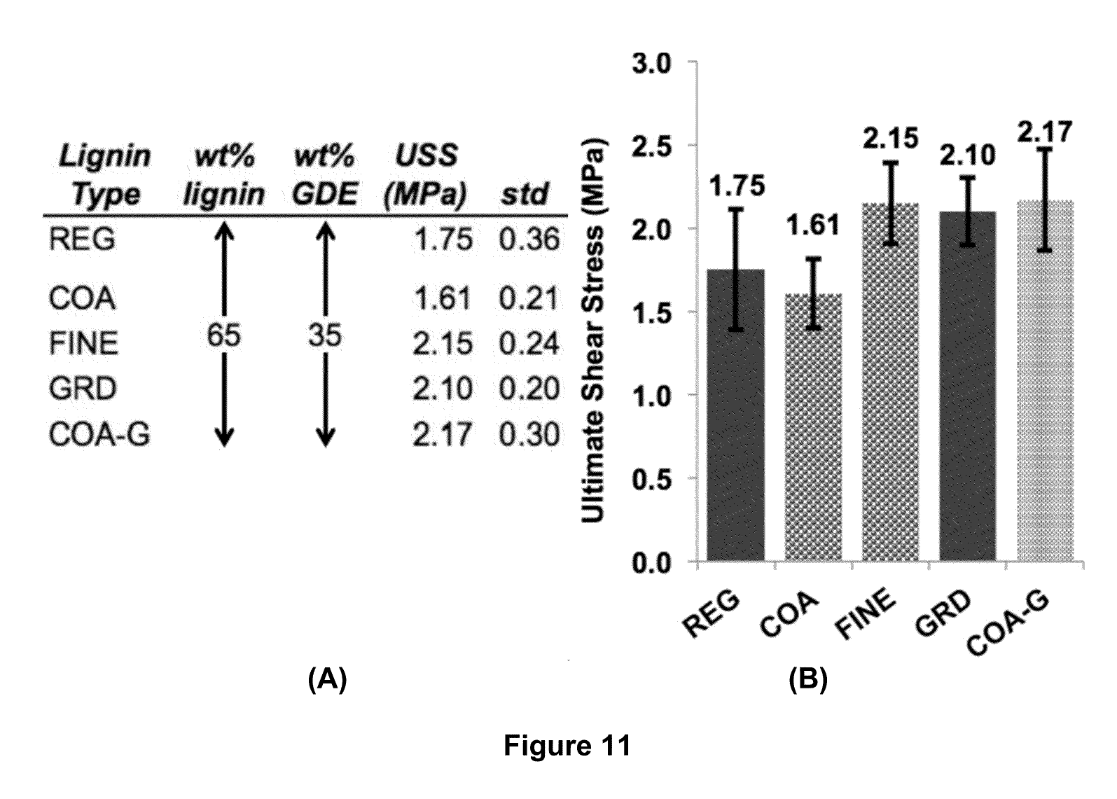

As shown in FIG. 10, using ball mill homogenized lignin (GRD) allows less GDE for the formulation to transition to a liquid state. As shown in FIG. 11, using ball mill homogenized lignin (GRD) also results in greater adhesion strength.

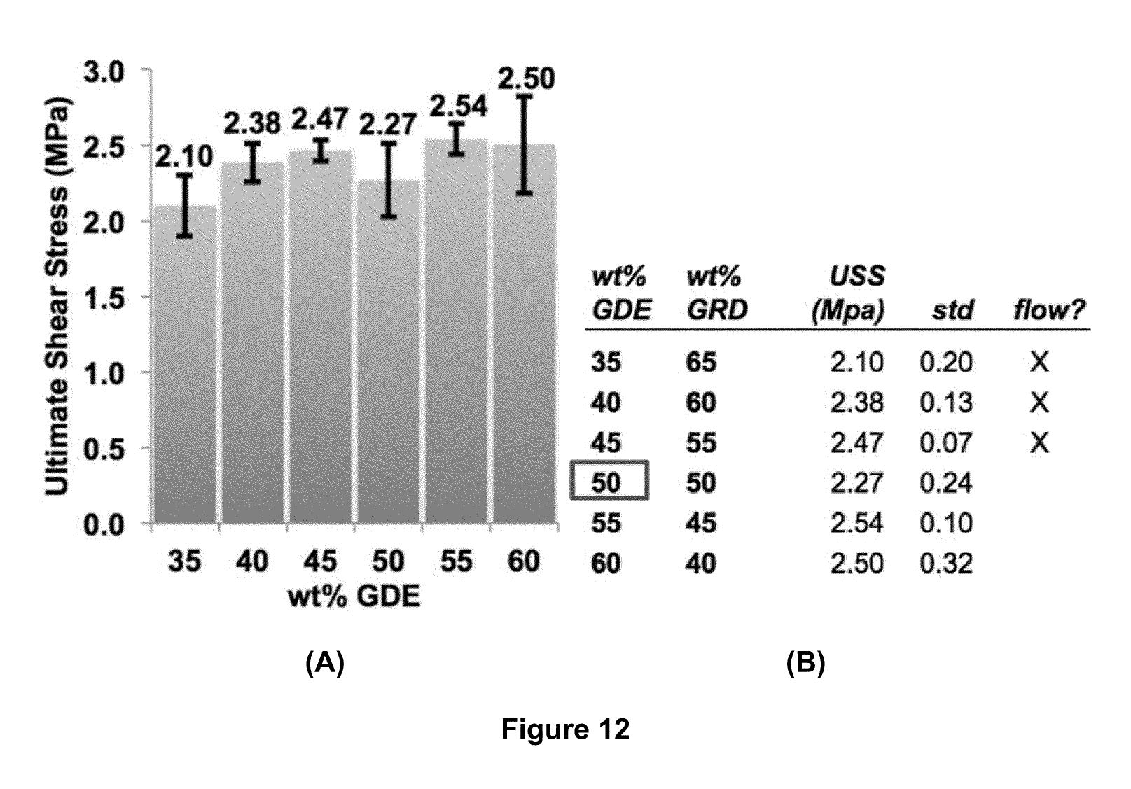

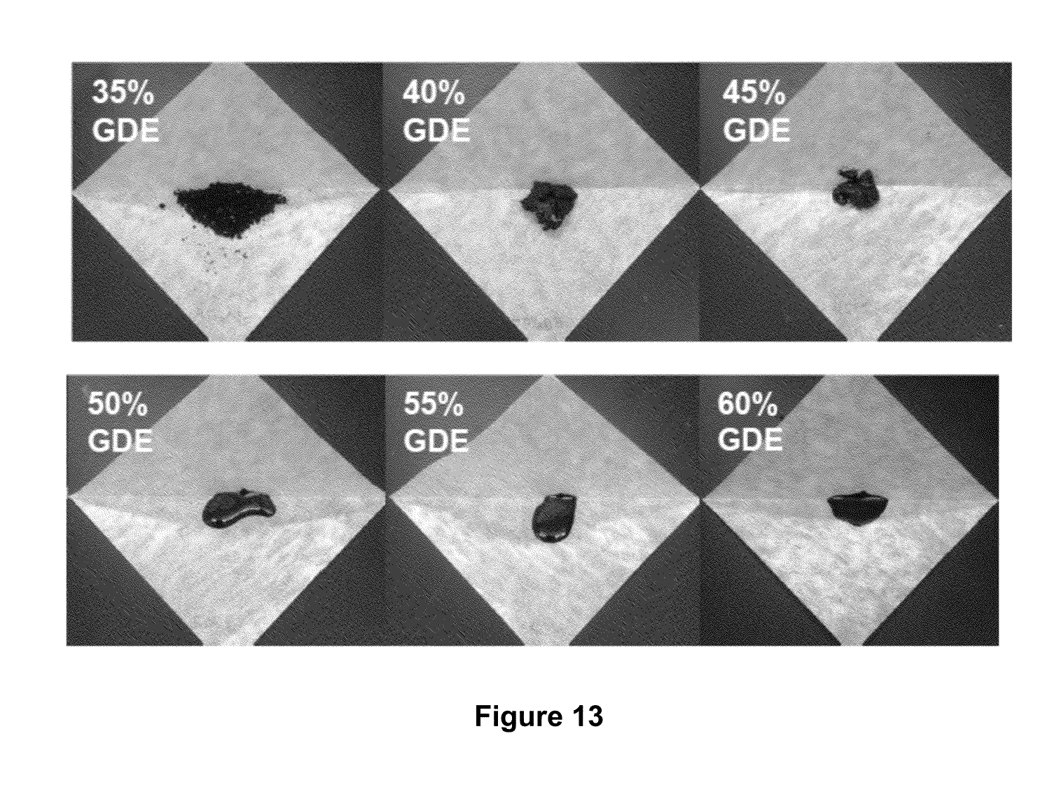

As shown in FIGS. 12 and 13, increasing the weight percentage of the cross-linker (e.g., GDE) can transition the lignin-based resin from solid state to liquid state, without sacrificing adhesion strength.

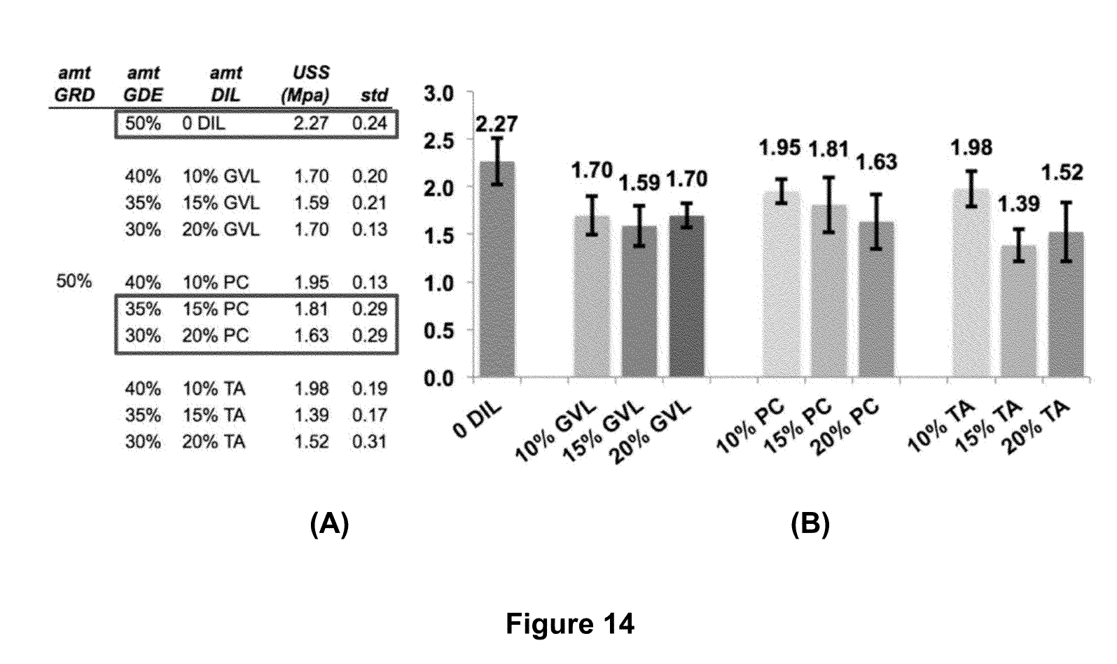

As shown in FIG. 14, replacing up to 20% of GDE in the resin with a dispersant/diluent can retain liquid state of the resin and also its adhesion strength.

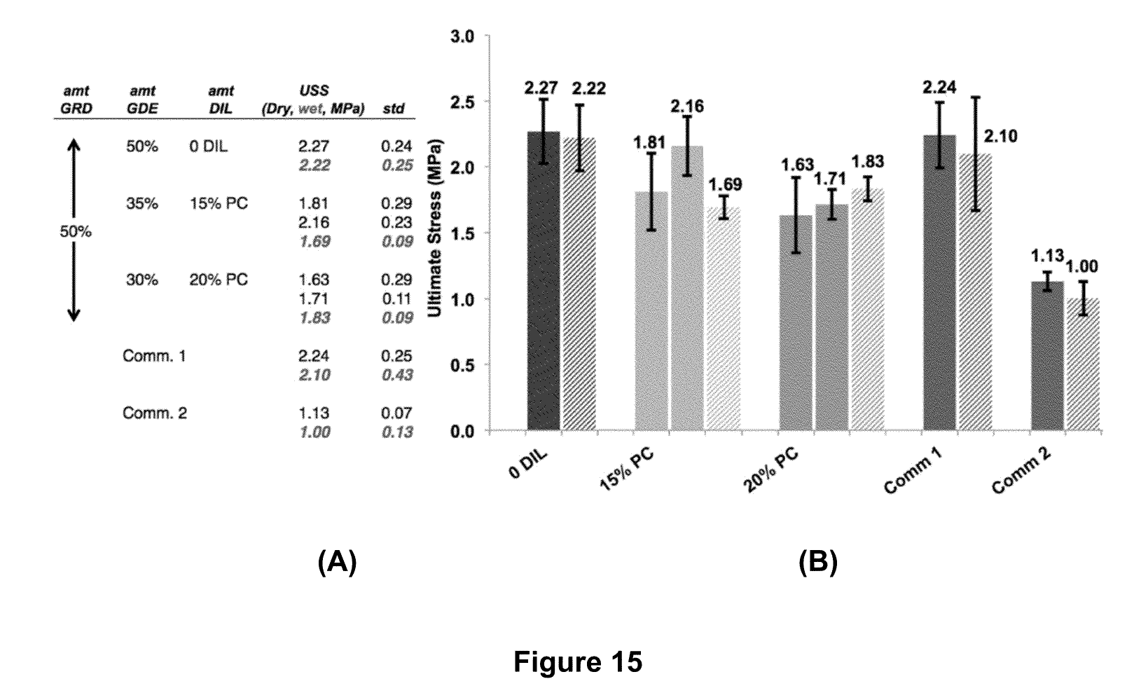

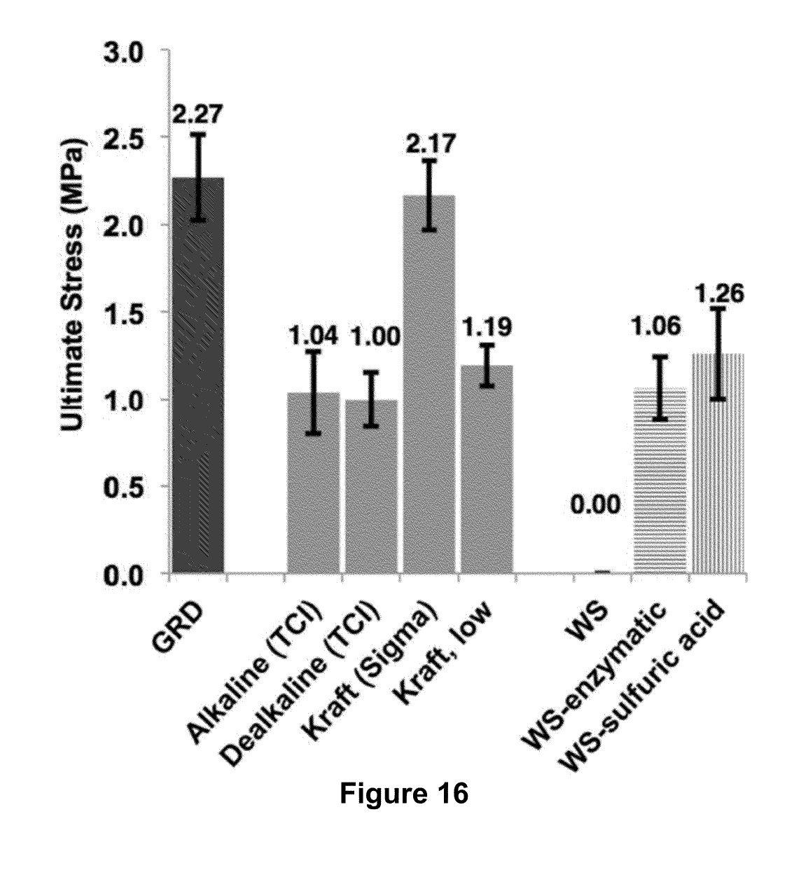

As shown in FIG. 15, the tolerance of the resin to wet conditions was also tested. As shown in FIG. 16, the inventive adhesive formulation and method described herein can be applied to ground lignin from various sources and waste lignin from various industrial streams.

As used herein, the singular terms “a,” “an,” and “the” include plural referents unless the context clearly dictates otherwise. Thus, for example, reference to a marker can include multiple markers unless the context clearly dictates otherwise.

As used herein, the terms “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

In the foregoing description, it will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations, which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scopes of this invention.

What is claimed is:

1. An adhesive formulation comprising lignin, a cross-linker, and optionally a dispersant, or obtained by mixing lignin, a cross-linker, and optionally a dispersant.

2. The adhesive formulation of claim 1, wherein the lignin is selected from the group consisting of waste lignin, extracted lignin, and synthetic lignin.

3. The adhesive formulation of claim 1, wherein the lignin is not pre-activated, pre-fractionated, or pre-functionalized.

4. The adhesive formulation of claim 1, wherein at least 50 wt. % of the formulation is lignin.

5. The adhesive formulation of claim 1, wherein the cross-linker is selected from the group consisting of glycerol diglycidyl ether and poly(ethylene glycol)diglycidyl ether.

6. The adhesive formulation of claim 1, wherein the dispersant is selected from the group consisting of gamma-valerolactone, propylene carbonate, ethylene carbonate, and triacetin.

7. The adhesive formulation of claim 1, wherein at least 50 wt. % of the formulation is waste lignin, wherein the lignin is not pre-activated, pre-fractionated, or pre-functionalized, wherein the cross-linker is glycerol diglycidyl ether, and wherein the dispersant is gamma-valerolactone.

8. The adhesive formulation of claim 1, wherein the lignin is obtained by ball mill homogenization.

9. The adhesive formulation of claim 1, wherein the formulation comprises an amount of the cross-linker effective to transition the formulation into a liquid state.

10. The adhesive formulation of claim 1, wherein 20 wt. % or less of the formulation is the dispersant.

11. The adhesive formulation of claim 1, wherein the formulation consists essentially of the lignin and the cross-linker, and wherein the formulation is in a liquid state.

12. The adhesive formulation of claim 1, wherein the formulation consists essentially of the lignin, the cross-linker and the dispersant, and wherein the formulation is in a liquid state.

13. A method for making a lignin-epoxy resin, comprising curing the adhesive formulation of claim 1.

14. A lignin-epoxy resin made by the method of claim 13.

15. A method for making a plywood assembly, comprising applying the adhesive formulation of claim 1 onto plywood and curing the adhesive formulation.

16. A plywood assembly made by the method of claim 15.

17. A method for making a lignin-fiber composite, comprising applying the adhesive formulation of claim 1 onto burlap fiber and curing the adhesive formulation.

18. A lignin-fiber composite made by the method of claim 17.

19. A method for making a lignin-waste wood composite, comprising mixing the adhesive formulation of claim 1 with waste wood or waste lignocellulose and curing the resulting mixture.

20. A lignin-waste wood composite made by the method of claim 19.
